(19) United States
(12) Patent Application Publication
(10) Pub. No.: US 2019/0353893 A1
(43) Pub. Date: Nov. 21, 2019

(54) Micromechanical Optical Phased Array

(71) Applicant: The Regents of the University of California, Oakland, CA (US)

(72) Inventors: Ming Chiang A WU, Moraga, CA (US); Guangya ZHOU, Singapore (SG); Youmin WANG, Berkeley, CA (US)

(21) Appl. No.: 16/473,707

(22) PCT Filed: Jan. 15, 2018
(86) PCT No.: PCT/US2018/013727

§ 371 Date: Jun. 26, 2019

Related U.S. Application Data
(60) Provisional application No. 62/446,260, filed on Jan. 13, 2017.

(51) Int. Cl. G02B 26/02; G02B 26/08

(52) U.S. Cl. CPC G02B 26/02; G02B 26/0841; G02B 26/0808

(57) ABSTRACT

A MEMS-based optical phased array (OPA) having small pitch, high fill factor, and large field of view is presented. The OPA includes a plurality of diffractive elements, each of which diffracts incident light into its diffractive orders to produce at least one beamlet. Each diffractive element is operatively coupled with an actuator that is operative for moving the diffractive element along its longitudinal direction to control the phase of its respective beamlet. The beamlets from all of the diffractive elements are combined to define at least one output beam and steer that output beam in at least one dimension.

### CROSS REFERENCE TO RELATED APPLICATIONS

This application claims the benefit of U.S. Provisional Application Ser. No. 62/446,260, filed Jan. 13, 2017, entitled “MEMS-Actuated Grating-Based Optical Phased Array” (Attorney Docket: 332-005PR1), which is incorporated herein by reference. If there are any contradictions or inconsistencies in language between this application and one or more of the cases that have been incorporated by reference that might affect the interpretation of the claims in this case, the claims in this case should be interpreted to be consistent with the language in this case.

### FIELD OF THE INVENTION

The present invention relates to optical phased arrays in general and, more particularly, to micromechanical optical phased arrays.

### BACKGROUND OF THE INVENTION

Optical phased arrays (OPAs) are optical systems comprising a plurality of surface elements that collectively form and/or direct one or more optical beams through two- or three-dimensional space by controlling the phase of light waves transmitted or reflected by each surface element. An OPA is analogous to a phased array antenna. Phased-array beam steering is currently used for optical switching and multiplexing in optoelectronic devices, as well as for aiming laser beams on a macroscopic scale.

The most common technologies used in optical phased arrays (OPA) are liquid crystal phase shifters, MEMS-based piston or grating-based mirrors, and integrated-optics-based surface waveguide arrays, such as the liquid-crystal-based phase shifters disclosed by McManamon, et al., in “Optical phased array technology,” Proceedings of the IEEE, Vol. 84, pp. 268-298, (1996), the MEMS-based OPAs disclosed by Yoo, et al., in “A 32×32 optical phased array using polysilicon sub-wavelength high-contrast-grating mirrors,” Optics Express, Vol. 22, p. 19029, (2014), and integrated-optics-based waveguide arrays disclosed by Hutchison, et al., in “High-resolution aliasing-free optical beam steering,” Optica, Vol. 3, p. 887, (2016).

Unfortunately, prior-art OPAs have many drawbacks. Liquid crystal OPAs, for example, are known to have relatively slow response times and are highly temperature sensitive.

Micromechanical, or MEMS-based, OPAs employing piston-actuated mirrors, while achieving fast response times, have been difficult to realize with a large field-of-view (FOV) because of the very small pitch required. For example, OPAs based on MEMS laterally moving grating elements have recently been disclosed by Zhou, et al., in “Nondispersive optical phase shifter array using microelectromechanical systems based gratings,” Optics Express, Vol. 15, pp. 10958-10963, (2007), but the width of these phase shifters is limited by the size of the actuators.

The need for a device technology that enables high-speed, large FOV OPAs remains, as yet, unmet in the prior art.

### SUMMARY OF THE INVENTION

The present invention enables an OPA operative for producing and steering one or more output optical beams in one or two dimensions and/or synthesizing any arbitrary wavefront (i.e., beamforming) with large field of view and high efficiency. OPAs in accordance with the present invention higher fill factor and smaller pitch than possible in prior-art OPAs. Embodiments of the present invention are particularly well suited for use in telecommunications systems, LiDAR, three-dimensional imaging, hyperspectral imaging, and optical sensing applications.

OPAs in accordance with the present invention employ an arrangement of co-planar diffractive elements, each of which diffracts light incident upon it into a beamlet corresponding to one of its diffraction orders. By controlling the relative phases of the beamlets produced by the collection of diffractive elements, a composite output signal can be shaped and steered in at least one dimension. Embodiments of the present invention exploits that fact that a change in the phase of light of a diffraction order produced by each diffractive element can be achieved by changing its lateral position along the direction perpendicular to its grating lines.

An illustrative embodiment of the present invention is an OPA that includes a linear array of diffraction elements, each of them mechanically coupled with a MEMS actuator that is operative for laterally displacing its respective diffraction element along its longitudinal axis. An input beam of light is directed at the OPA such that its light is incident on the diffractive elements. Each diffractive element diffracts the light incident upon it into a beamlet characterized by the first diffractive order. Each actuator positions its respective diffraction element to provide its output beamlet with a desired phase.

In some embodiments, an OPA comprises a two-dimensional array of diffraction elements whose actuator is located beneath it. In some two-dimensional embodiments, the actuators of adjacent diffraction elements are staggered such that each has a footprint that is larger than its respective diffraction element in at one dimension.

In some embodiments, the arrangement of diffraction elements is aperiodic in at least one dimension, which facilitates suppression of sidelobes and enables a large field of view.

An embodiment of the present invention is an optical phased array (300) comprising: a plurality of diffractive elements (304) that are co-planar in a first plane (P2), wherein each diffractive element is configured to receive light of a first optical beam (104) and diffract the light to provide a beamlet (324); and a plurality of actuators (306), each actuator of the plurality thereof being operative for imparting a first motion on a different diffractive element of the plurality thereof, wherein the first motion is in a first direction (D1) that is substantially aligned with the first plane; wherein the phase of each beamlet of the plurality thereof is based on the position along the first direction of its respective diffractive element; and wherein the plurality of beamlets interact to provide at least one second optical beam (326).

Another embodiment of the present invention is a method comprising: receiving an input beam (104) at an optical phased array (OPA) comprising a plurality of diffractive elements (304) that are co-planar in a first plane (P2); diffracting light incident on each diffractive element of the plurality thereof into a beamlet (324); controlling a first position of each diffractive element along a first direction (D1) in the first plane, wherein the phase of each beamlet of the plurality thereof is based on the first position; and combining the plurality of beamlets to form an output signal (326).

### BRIEF DESCRIPTION OF THE DRAWINGS

FIG. 1 depicts an exemplary interaction between a diffraction grating and an incoming light signal in accordance with the present invention.

FIG. 2 depicts an exemplary interaction between a planar mirror and an incoming light signal.

FIG. 3A depicts a schematic drawing of a top view of a MEMS-based optical phased array in accordance with an illustrative embodiment of the present invention.

FIG. 3B depicts a schematic drawing of an enlarged perspective view of a portion of an individual grating element in accordance with the illustrative embodiment.

FIG. 3C depicts a schematic drawing of a perspective view of the operation of a representative diffractive element in accordance with the illustrative embodiment.

FIGS. 4A-C depict schematic drawings of top views of alternative arrangements of actuators in accordance with the present invention.

FIG. 5 depicts a schematic drawing of a perspective view of a grating element in accordance with a first alternative embodiment of the present invention.

FIG. 6 depicts a schematic drawing of an OPA in accordance with a second alternative embodiment of the present invention.

FIG. 7 depicts a schematic drawing of a top view of a portion of a two-dimensional OPA in accordance with the present invention.

### DETAILED DESCRIPTION

The present invention exploits the fact that an in-plane translational motion of a diffraction grating gives rise to an instantaneous frequency shift due to the Doppler Effect. As a result, embodiments of the present invention include actuators for imparting such motion on diffraction grating elements with which they are mechanically coupled.

### Principle of Operation

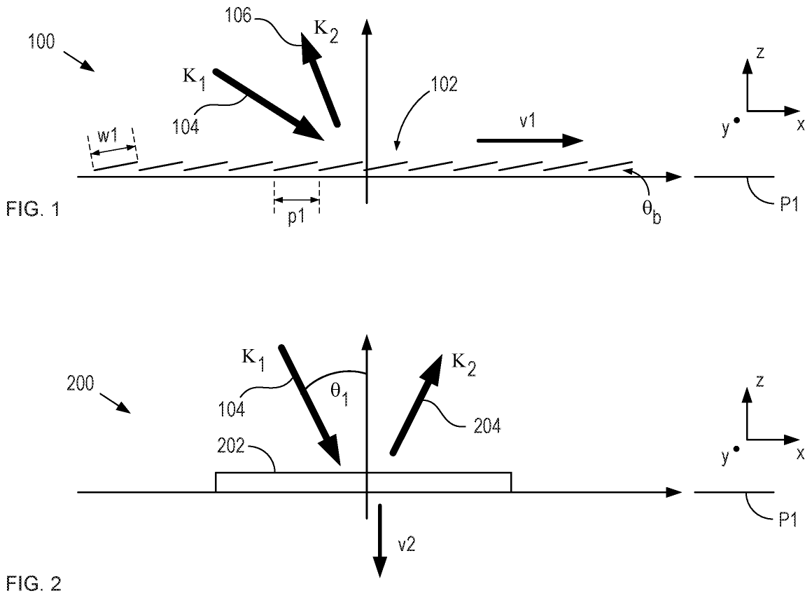

FIG. 1 depicts an exemplary interaction between a diffraction grating and an incoming light signal in accordance with the present invention. Diffraction grating 100 is a blazed grating that includes grating elements 102, which are arranged in periodic fashion along the x-direction.

Each of grating elements 102 is substantially mechanically rigid slat of material that is substantially reflective for light beam 104. Each of grating elements 102 has width, w1, (i.e., its dimension in the x-direction) and a length (i.e., its dimension in the y-direction) that is typically much larger than w1. In some embodiments, grating elements 102 are made of a material that is substantially transmissive for light beam 104.

Grating elements 102 are arranged along the x-direction with period, p1, and are oriented blaze angle, θ_{b}, with respect to x-y plane, P1.

Light beam 104 is a collimated light signal that is characterized by the expression: A exp[i(k₁·r−ωt)], where k₁ is the wave-vector of light beam 104 and ω is its angular frequency.

The interaction of light signal 104 with diffraction grating 100 gives rise to diffracted beam 106, which is characterized by the expression: B exp[i(k₂·r−ωt)], where k₂ is the wave-vector of diffracted beam 106.

In the depicted example, when grating 100 is moved along the x-direction (i.e., within x-y plane P1) with velocity v1, diffracted beam 106 experiences an instantaneous frequency shift according to the Doppler Effect as follows:

Δω=(k₂−k₁)·v1=(k′₂−k′₁)·v1, (1)

where k′₁ and k′₂ are the projections of the wave-vectors on the grating surface, which fulfill the grating equation:

k′₂−k′₁=−mk_{G}, (2)

where m is the diffraction order and k_{G} is the grating vector, which is defined as the vector perpendicular to the grating lines, and which has a magnitude equal to 2π/p1.

As a result, the description of diffracted beam 106 becomes:

B exp{i[k₂·r−(ω+Δω)t]=B exp[im(k_{G}·v1)t] exp[i(k₂·r−ωt)]. (3)

When grating 100 moves along the x-direction by a distance d, then the diffracted wave becomes:

B exp[im2πd/p1] exp[i(k₂·r−ωt)]. (4)

Therefore, phase shift φ1 is added to the diffracted beam, where the phase shift is equal to:

φ1=m2πd/p1. (5)

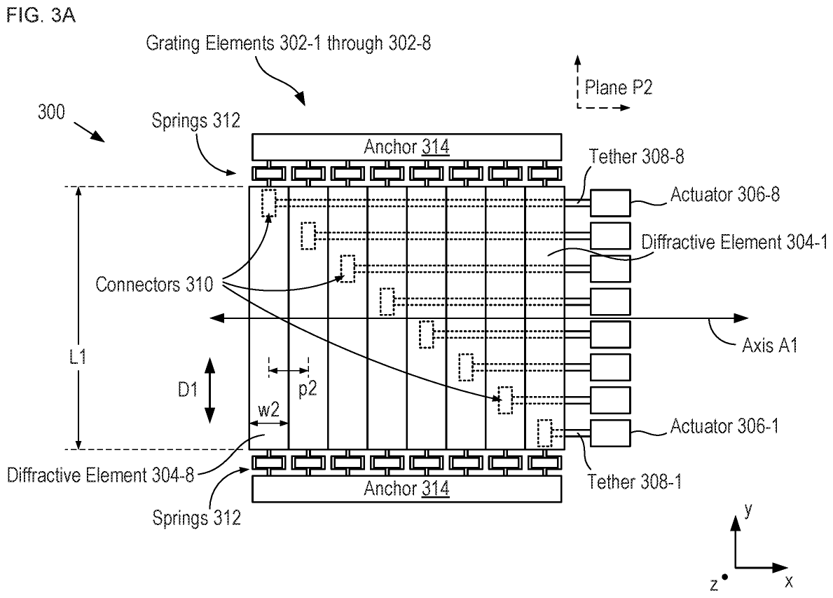

FIG. 2 depicts an exemplary interaction between a planar mirror and an incoming light signal. Mirror 200 is a conventional flat mirror that includes surface 202, which lies within x-y plane P1.

Surface 202 is a layer that is substantially reflective for light beam 104. Surface 202 is formed on the top surface of mirror 202 such that the mirror is a first-surface reflector.

The illumination of mirror 200 with light beam 104 give rise to reflected beam 204, which is described by is B exp[i(k₂·r−ωt)].

When mirror 200 moves along the z-direction (i.e., along a direction perpendicular to its surface in the x-y plane) with velocity v2, the Doppler effect gives rise to an instantaneous frequency shift described by:

Δω=(k₂−k₁)·v2, (6)

and the reflected wave becomes:

B exp{i[k₂·r−(ω+Δω)t]=B exp[−i(k₂−k₁)·v2·t] exp[i(k₂·r−ωt)], (7)

When mirror 102 moves a distance d, the reflected wave becomes:

B exp[i4π cos(θ₁)d/λ] exp[i(k₂·r−ωt)], (8)

where θ1 is the incidence angle. As a result, phase shift φ2 is added to the reflected beam, where the phase shift is equal to:

φ2=4π cos(θ)d/λ, (9)

It is an aspect of the present invention that the phase shift produced by motion of a mirror depends on wavelength and incident angle, but the phase shift produced by motion of a diffractive grating is independent of the wavelength and incident angle, which is evident from a comparison of Eqs. (9) and (5).

Embodiments of the present invention, therefore, are afforded significant advantages over prior art OPAs, some of which are summarized below in Table 1, relative to competing technologies:

TABLE 1
Advantages of embodiments of the present invention
with respect to other OPA technologies.

| Competing | |
|---|---|
| Technology | Advantages Afforded by the Present Invention |
| Integrated- | Free-space operation without requiring waveguides; |
| Photonic OPA | therefore, inherently more efficient due to lack of |
| | waveguide coupling and propagation losses. |
| | Operation at substantially any wavelength due to lack |
| | of waveguide-material limitations. |
| | Potential for large aperture size with near 100% |
| | fill factor. |
| Micromirror- | Each element can impart a phase shift that is both |
| Array OPA | angle and wavelength independent. |
| | Imparted motion is in-plane; therefore, linear comb- |
| | drive can be used for actuation. |
| | All grating elements are in the same plane during |
| | operation; therefore, no shadowing of neighboring |
| | elements occurs - even at very large field of view. This |
| | leads to higher optical efficiency and reduced sidelobes. |
| Liquid-Crystal | Faster response time due to the MEMS driving |
| OPA | mechanisms. |
| | No need for polarizers. |
| | Operation at substantially any wavelength. |
| | Substantially temperature insensitive, which provides a |
| | wider range of operating temperature. |

Furthermore, one skilled in the art will recognize that fill factor and OPA pitch are important design parameters. The present invention enables small-pitch OPAs, which can have larger fields of view and higher fill factor (near 100%), thereby providing highly efficient light-energy utilization and reduced beam sidelobes.

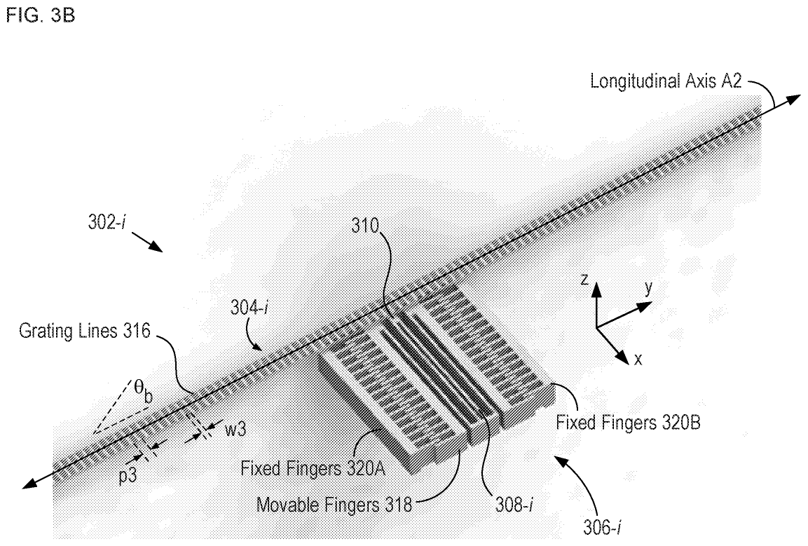

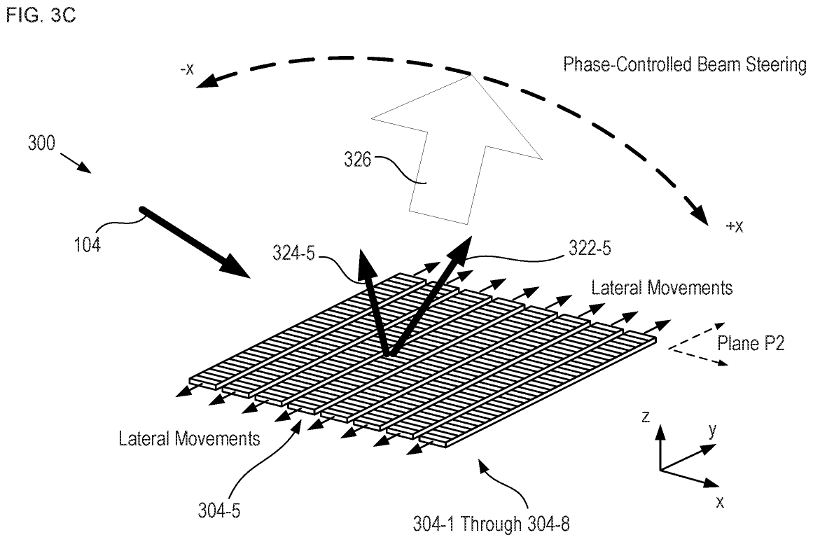

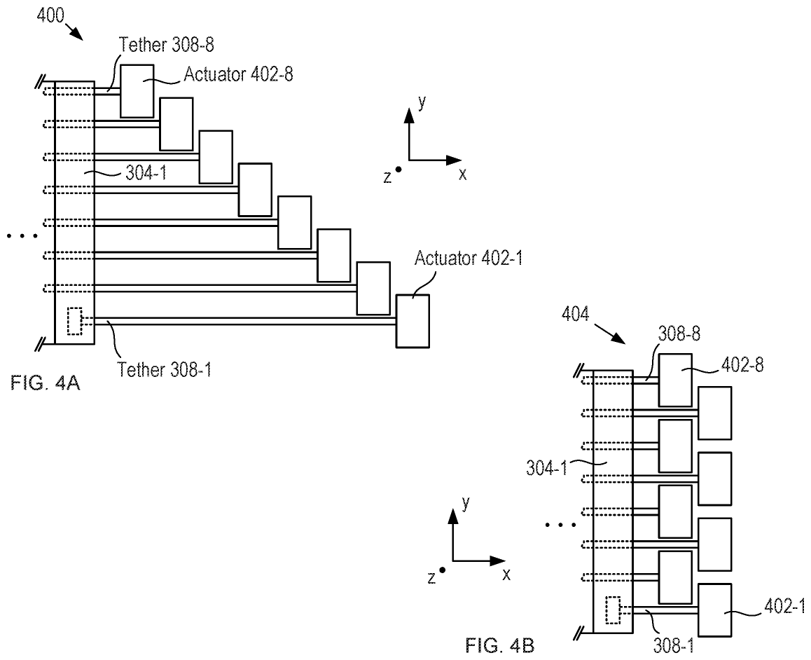

FIG. 3A depicts a schematic drawing of a top view of a MEMS-based optical phased array in accordance with an illustrative embodiment of the present invention. OPA 300 includes grating elements 302-1 through 302-8 (referred to, collectively, as grating elements 302), which are co-planar in the x-y plane, P2, and arrayed along the x-direction with period p2. OPA 300 is operative for reflecting an input light beam as an output light beam and steering the output light beam along the x-direction. It should be noted that, although OPA 300 includes eight grating elements, any practical number of grating elements can be included in an OPA without departing from the scope of the present invention.

OPA 300, as well as other embodiments of the present invention, are preferably fabricated via MEMS fabrication methods, such as those described in PCT Patent Application PCT/US17/38232 and “MEMS Optical Phase Array,” 21^{st} Microoptics Conference (MOC '16), Berkeley, Calif., USA, October 12-14 (2016), each of which is incorporated herein by reference.

FIG. 3B depicts a schematic drawing of an enlarged perspective view of a portion of an individual grating element in accordance with the illustrative embodiment. Grating element 302-i is representative of each of grating elements 302. Grating element 302-i includes diffractive element 304-i, actuator 306-i, tether 308-i and connector 310.

Diffractive element 304-i is a blazed diffraction grating having overall width w2 and overall length L1. Diffractive element 304-i analogous to blazed grating 100 described above and with respect to FIG. 1. Typically, w2 is slightly smaller than the pitch, p2, of the array of grating elements 302.

Diffractive element 304-i includes a plurality of parallel grating lines 316 having width w3, where each grating line is oriented at blaze angle, θ_{b}, relative to the x-y plane, as discussed above. Grating lines 316 are arrayed along the y-direction with pitch p3. Diffractive element 304-i is configured (i.e., its grating line width, w3, pitch p3, blaze angle, θ_{b}, etc., are selected) for operation at the wavelength of input beam 104, which is typically a wavelength within the visible or near-infrared (NIR) wavelength ranges. It will be clear to one skilled in the art, after reading this Specification, how to specify, make, and use diffractive element 304-i.

Actuator 306-i is a conventional comb-drive actuator operative for imparting linear motion of diffractive element 304-i along direction D1, which is aligned with the y-direction. Actuator 306-i includes movable fingers 318 and two sets of fixed fingers 320A and 320B. The fixed and movable fingers are interleaved such that a voltage potential applied between the movable fingers and one of the sets of fixed fingers gives rise to an attractive force that draws the movable fingers more deeply into that set of fixed fingers.

Although actuator 306-i is an electro-static comb-drive actuator in the depicted example, in some embodiments, an OPA includes at least one actuator that is other than an electro-static comb-drive actuator. Actuators suitable for use in embodiments of the present invention include, without limitation, other electrostatic actuators, thermal actuators, piezoelectric actuators, electromagnetic actuators, and the like.

Tether 308-i is a beam of structural material that is configured to bend in the y-direction but be substantially inflexible in each of the x- and z-directions.

Connector 310 is a structurally rigid element of structural material that is affixed to diffractive element 304-i. Connector block 310 is mechanically coupled with movable fingers 318 via connector and tether 308-i. As a result, motion of movable fingers 318 of actuator 306-i, imparts motion on diffractive element 304-i.

As shown in the depicted example, each of diffractive elements 302 is supported above a common substrate (not shown) by optional springs 312, which extend from each end of the diffractive element to a fixed-position anchor 314. Each of springs 312 is a flexible element of structural material that is configured to selectively enable motion of the diffractive element along the y-direction.

In some embodiments, diffractive elements 302 are supported above their common substrate by flexural elements that act as vertical springs having flexure only along the y-direction.

In some embodiments, these vertical springs are formed by depositing structural material in conformal fashion on regions of sacrificial material disposed on the substrate. The structural material is then patterned to define regions disposed on the appropriate sidewalls (i.e., sidewalls that are oriented in the x-z plane) of the sacrificial regions, where each such region defines a nascent vertical spring. Preferably, the width (i.e., their x-dimension) and height (i.e., their z-dimension) of these regions are significantly greater than their thickness (i.e., their y-dimension) to substantially restrict their flexure to the y-direction once they are released. Once the vertical springs are fully defined, the diffractive element and movable comb fingers of the grating phase shifter are formed such that they are mechanically coupled with their respective vertical springs.

Upon removal of the sacrificial region, each vertical spring has a thickness that is equal to the deposition thickness of the layer of structural material from which it is formed. Since the deposition thickness is typically quite thin, the springs are relatively flexible in the y-direction and, as a result, enable motion of their respective movable elements without significantly reducing the fill factor of the OPA.

Preferably, the springs and actuators are configured to collectively enable a range of motion for each of diffractive elements 304-1 through 304-8 (referred to, collectively, as diffractive elements 304) that is sufficient to impart at least a full 2π phase shift on its reflected light beams. In some embodiments, however, the springs and actuators enable a range of motion that is less than 2π.

In the depicted example, the structural material of each of diffractive element 304-i, actuator 306-i, tether 308-i and connector 310 is single-crystal silicon; however, it will be clear to one skilled in the art, after reading this Specification, that myriad structural materials suitable for use in MEMS fabrication can be used for one or more of the structural elements of grating element 302-i. Structural materials suitable for use in embodiments of the present invention include, without limitation, silicon, polysilicon, low-stress polysilicon, silicon compounds (e.g., silicon carbide, silicon germanium, etc.), compound semiconductors, ceramics, metals, low-stress dielectrics (e.g., silicon-rich silicon nitride, etc.), composite materials, and the like.

When light beam 104 is incident on OPA 300, each diffractive element 304 diffracts the light incident upon it into beamlets according to the diffraction-orders of the grating. Since each of diffractive elements 304 is a blazed grating structure, the majority of its output optical energy is directed into its first-order beam, which propagates away from the diffractive element at an angle that is based the angle of incidence of input beam 104 and the blaze angle, θ_{b}, of grating lines 316.

FIG. 3C depicts a schematic drawing of a perspective view of the operation of a representative diffractive element in accordance with the illustrative embodiment.

Diffractive element 304-5 the light incident upon it into two principal diffraction orders—namely, zeroth-order beamlet 322-5 and first-order beamlet 324-5. It should be noted that the operation of diffraction element 304-5 is representative of the operation of each of diffractive elements 304.

When OPA 300 is in its quiescent state, the grating lines of its diffraction elements are aligned along the y-direction to collectively form a single blazed grating. As a result, the first-order beamlets provided by the diffraction elements are in phase and output beam 326 propagates along an initial direction that is dictated by the design of diffractive elements 304 and the angle of incidence of input beam 104.

As discussed above and with respect to FIG. 1, the optical phase of the first-order beam reflected from a diffractive element is based on the lateral (in-plane) position of that diffractive element. By controlling the position of each of diffraction element 304, therefore, the phase of its first-order beamlet can be controlled. As provided in Eq. (5) above, the derived phase shift of an output beamlet is:

Δφ=2πd/p3,

where Δφ is the phase shift caused by the lateral displacement, d. It should be noted that the phase shift is dependent only on the ratio of the in-plane displacement, d, to the grating pitch, p3 (i.e., it is independent of wavelength).

As a result, a desired phase relationship among all of the first-order beamlets provided by diffraction elements 304 can be established by locating them in positions along the y-direction that give rise to constructive and destructive interference between their beamlets, thereby shaping output beam 326 and controlling its direction of propagation.

In some embodiments, OPA 300 includes diffractive elements other than blazed gratings, such as non-blazed diffraction gratings, holographic elements, and the like. Furthermore, in some embodiments, diffractive elements 302 are transmissive for light beam 104.

In some embodiments, OPA 300 also controls the propagation direction of the diffracted beam along the y-direction by controlling the wavelength of light signal 104.

It should be noted that, by controlling the optical phases of OPA 300 accordingly, the OPA can provide more general optical beamforming functions, including independent steering of multiple optical beams, simultaneous scanning and tracking, beam scanning with variable field of view or resolution, and the like.

In the depicted example, actuators 306 are linearly arranged along the y-direction. In some embodiments, however, it is desirable to employ actuators having larger ranges of motion than can be achieved by a linear arrangement.

It is an aspect of the present invention that the OPA pitch (p2, in the depicted example) can have a significant impact on the quality of output beam 326. As a result, in some embodiments of the present invention, the OPA pitch is selected to provide a particular characteristic of the output beam, such as suppressed sidelobes, increased optical field of view, etc. In some embodiments, this is achieved by providing the OPA pitch as non-uniform (i.e., aperiodic) and/or including diffractive elements of different widths.

In some embodiments, the ratio of the wavelength of input beam 104 to OPA pitch, p2, is within the range of approximately 0.1 to approximately 2. In some embodiments, the wavelength is equal to p2/10, in some embodiments, the wavelength is equal to p2/2, in some embodiments, the wavelength is equal to p2, and in some embodiments, the wavelength is equal to twice p2.

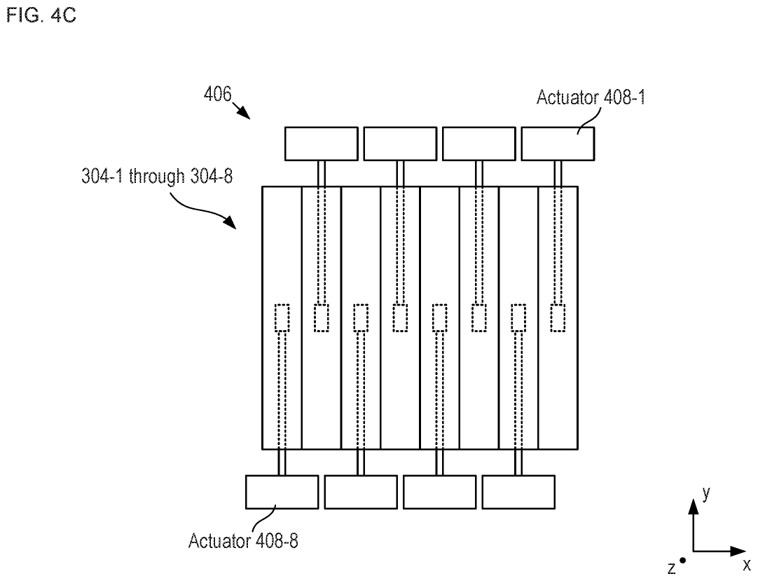

FIGS. 4A-C depict schematic drawings of top views of alternative arrangements of actuators in accordance with the present invention.

Actuator arrangement 400 is an arrangement of actuators that is indexed in the x-direction such that each successive actuator 402 is at greater distance from the array of diffraction elements.

In similar fashion, actuator arrangement 404 is an arrangement of actuators that is staggered such that alternating actuators 402 are at different distances from the array of diffraction elements.

Actuator arrangement 406 is an arrangement of actuators 408, each of which is analogous to actuator 402; however, each actuator 408 is configured such that its movable comb fingers move along the y-direction such that the actuator pulls or pushes its respective diffractive element 304 along the y-direction. Actuators 408 are arranged such that they are distributed on either side of the diffraction elements. As a result, actuators 408 can occupy up to approximately twice the width available for actuators 306 described above.

In each of actuator arrangements 400 through 406, the available real estate available for actuators 402 is greater than that in OPA 300. As a result, each actuator 402 can have greater range of motion along the y-direction than actuators 306, while still enabling an extremely small grating pitch and high OPA fill factor.

It should be noted that the arrangements of actuators described herein are merely exemplary and that myriad alternative actuator arrangements can be used in embodiments of the present invention without departing from its scope.

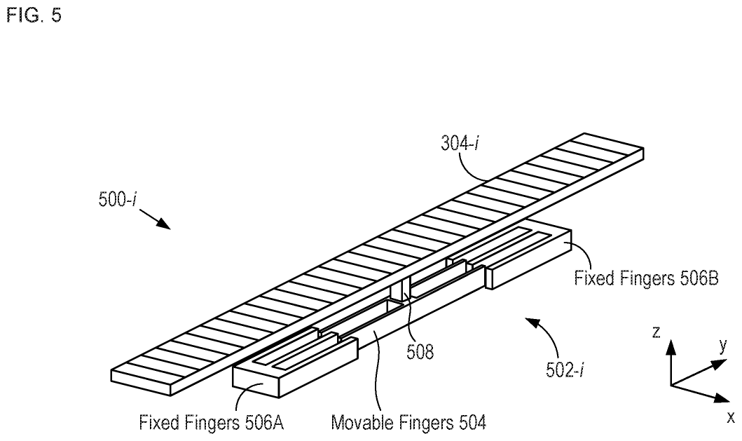

FIG. 5 depicts a schematic drawing of a perspective view of a grating element in accordance with a first alternative embodiment of the present invention. Grating element 500 is analogous to grating element 302-i; however, the actuator of grating element 500 is located completely underneath its diffractive element. As a result, grating element 500 enables an OPA that can have one or more of a smaller footprint, higher fill-factor (approaching 100%), reduced side lobes in its output beam, larger field of view, and improved light-energy utilization than is possible in the prior art.

Grating element 500-i comprises diffraction element 304-i, actuator 502-i, and post 508.

Actuator 502-i is analogous to actuator 306-i described above; however, actuator 502-i is configured such that it can reside completely underneath diffraction element 304-i. Actuator 502-i includes movable fingers 504 and two sets of fixed fingers—fixed fingers 506A and 506B. Fixed fingers 504 are mechanically coupled with diffraction element 304-i via post 508.

Like actuator 306-i, actuator 502-i is operative for moving diffraction element 304-i in either direction along the y-direction, depending upon which set of fixed fingers 506A and 506B is provided a voltage differential with movable fingers 504.

Since actuator 502-i resides completely beneath diffraction element 304-i, the total real estate required for an OPA based on grating element 500-i is reduced, as compared to OPA 300.

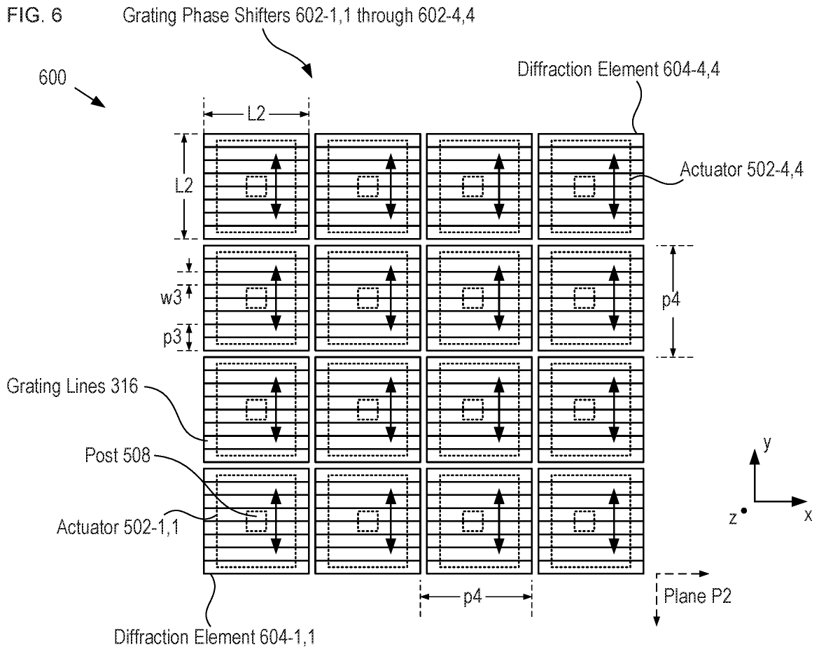

FIG. 6 depicts a schematic drawing of an OPA in accordance with a second alternative embodiment of the present invention. OPA 600 is analogous to OPA 300; however, OPA 600 is operative for steering one or more output beams in two dimensions. OPA 600 comprises grating phase shifters 602-1,1 through 602-4,4, which are arranged in a 4×4 array having uniform OPA pitch of p4 in each dimension. Although OPA 600 includes 16 grating phase shifters arranged in a 4×4 array, any number of grating phase shifters, arranged in any two-dimensional arrangement, can be used in embodiments of the present invention without departing from its scope. Grating-phase-shifter arrangements suitable for use in embodiments of the present invention include, without limitation, square arrays, rectangular arrays, diamond arrangements, triangular arrangements, arrangements with non-uniform spacing in at least one dimension, and the like.

Each of grating phase shifters 602-1,1 through 602-4,4 (referred to, collectively, as grating phase shifters 602) includes a substantially identical diffraction element 604 and a one-dimensional, electrostatic comb-drive actuator 502, which is mechanically coupled with the diffraction element via a connection post (not shown).

Diffraction element 604 is analogous to diffraction element 304; however, diffraction element 604 has a substantially square shape having sides of length, L2. Each diffraction element is a blazed grating that includes a plurality of grating lines 316, as discussed above.

By virtue of its actuator 502, each diffraction element 604 is movable along the y-direction to control the phase of its beamlet. By controlling the relative phases of the beamlets provided by grating phase shifters 602, the beamlets can be formed such that they define and steer a composite output beam along a desired path.

It should be noted that, like OPA 300, the optical phases of OPA 600 can be controlled to provide more general optical beamforming functions, including independent steering of multiple optical beams, simultaneous scanning and tracking, beam scanning with variable field of view or resolution, and the like.

As noted above, by locating each actuator 502 underneath its respective diffraction element, the depicted example enables an OPA having higher fill factor and smaller pitch than can be achieved in the prior art. By virtue of its small pitch, OPA 600 provides a large field of view, efficient light energy utilization, and reduced beam sidelobes.

As discussed above, it is an aspect of the present invention that the OPA pitch (p4, in the depicted example) can have a significant impact on the quality of the output beam or beams provided by an OPA. As a result, in some embodiments of the present invention, the OPA pitch in at least one dimension is selected to provide a particular characteristic of the output beam, such as suppressed sidelobes, increased optical field of view, etc. In some embodiments, this is achieved by providing the OPA pitch as non-uniform (i.e., aperiodic) and/or including diffractive elements of different widths in at least one dimension.

In some cases, it is desirable to increase the size of the actuators used to move the diffraction elements of an OPA. A larger actuator enables a lower drive voltage, stronger actuation force, and/or a larger range of motion.

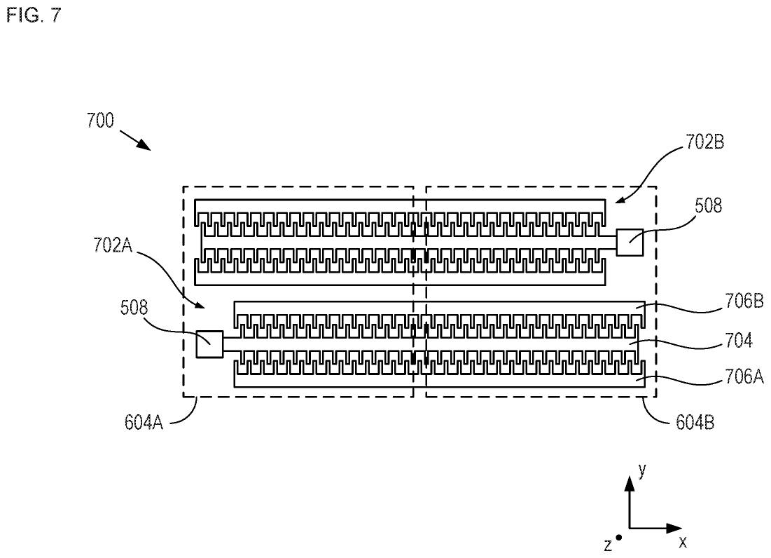

FIG. 7 depicts a schematic drawing of a top view of a portion of a two-dimensional OPA in accordance with the present invention. Unit cell 700 includes a pair of grating phase shifters—grating phase shifters 702A and 702B. Typically, unit cell 700 is repeated along each of the x- and y-directions to define a large-cell-count OPA. It should be noted that only the outlines of the diffractive elements of the grating phase shifters is shown in FIG. 7 to more clearly show the structure beneath them.

Each of grating phase shifters 702A and 702B includes a diffractive element 604, an actuator 702, and a connector post 508, which mechanically couples the diffractive element and the movable fingers of the actuator.

Each of actuators 702A and 702B includes a set of movable comb fingers 704 and a pair of sets of fixed comb fingers 706A and 706B. Operation of actuator 702 is analogous to the operation of actuator 306 described above.

Actuators 702A and 702B are interleaved such that each spans both of diffractive elements 604A and 604B. This enables a larger actuator footprint without detracting from the fill factor of the OPA. In fact, in the depicted example, the footprint of each of actuators 702A and 702B is larger than the footprint (in one dimension) than the diffractive element with which it is operatively coupled.

As mentioned above, enlarging a dimension of the actuator design relieves design constraints that arise from an OPA having a small array pitch size; therefore, it enables the travel range of the actuator to be large (preferably sufficient to effect a full 2π phase shift in its respective diffraction element) while maintaining small array pitch and near 100% fill factor.

It should be noted that an electrostatic linear comb-drive actuator is merely one of many actuator types suitable for use in embodiments of the present invention. Other actuators, such as thermal actuators, piezoelectric actuators, electromagnetic actuators, and the like, can be used in an OPA without departing from the scope of the present invention.

It is to be understood that the disclosure teaches just one example of the illustrative embodiment and that many variations of the invention can easily be devised by those skilled in the art after reading this disclosure and that the scope of the present invention is to be determined by the following claims.

What is claimed is:

1. An optical phased array (300) comprising:
a plurality of diffractive elements (304) that are co-planar in a first plane (P2), wherein each diffractive element is configured to receive light of a first optical beam (104) and diffract the light to provide a beamlet (324); and
a plurality of actuators (306), each actuator of the plurality thereof being operative for imparting a first motion on a different diffractive element of the plurality thereof, wherein the first motion is in a first direction (D1) that is substantially aligned with the first plane;
wherein the phase of each beamlet of the plurality thereof is based on the position along the first direction of its respective diffractive element; and
wherein the plurality of beamlets interact to provide at least one second optical beam (326).

2. The apparatus of claim 1 wherein at least one actuator (502) of the plurality thereof is located beneath its respective diffractive element (304).

3. The apparatus of claim 1 wherein the plurality of diffractive elements are linearly arranged along a first axis (A1) in the first plane, each diffractive element having a longitudinal axis (A2) that is orthogonal with the first axis, and wherein the first direction and the longitudinal axis are aligned.

4. The apparatus of claim 1 wherein the diffractive elements of the plurality thereof are arranged in an arrangement characterized by a first pitch along a second direction that is orthogonal with the first direction within the first plane, and wherein the ratio of the wavelength of the first optical beam to the first pitch is within the range of approximately 0.1 to approximately 2.

5. The apparatus of claim 4 wherein the ratio of the wavelength of the first optical beam to the first pitch is selected from the group consisting of 0.1, 0.5, 1, and 2.

6. The apparatus of claim 1 wherein the diffractive elements of the plurality thereof are arranged in an arrangement characterized by a non-uniform inter-element spacing along a second direction that is orthogonal with the first direction within the first plane.

7. The apparatus of claim 1 wherein the plurality of diffractive elements are arranged in an arrangement that is two-dimensional.

8. The apparatus of claim 7 wherein the arrangement is selected from the group consisting of a square, a rectangle, a diamond, and a triangle.

9. The apparatus of claim 7 wherein the arrangement is characterized by an inter-element spacing that is non-uniform in at least one dimension.

10. The apparatus of claim 7 wherein the arrangement is characterized by a first pitch along the first direction and a second pitch along a second direction that is orthogonal with the first direction within the first plane, and wherein the ratio of the wavelength of the first optical beam to the first pitch is within the range of approximately 0.1 to approximately 2, and further wherein the ratio of the wavelength of the first optical beam to the second pitch is within the range of approximately 0.1 to approximately 2.

11. The apparatus of claim 10 wherein the first pitch and second pitch are unequal.

12. The apparatus of claim 7 wherein at least one actuator (502) of the plurality thereof is located beneath its respective diffractive element (604).

13. The apparatus of claim 1 wherein the plurality of actuators is arranged such that adjacent actuators of the plurality thereof are centered at different positions along a second direction that is orthogonal with the first direction in the first plane.

14. The apparatus of claim 1 wherein each diffractive element of the plurality thereof has a first footprint and its respective actuator has a second footprint that is larger than the first footprint.

15. A method comprising:
receiving an input beam (104) at an optical phased array (OPA) comprising a plurality of diffractive elements (304) that are co-planar in a first plane (P2);
diffracting light incident on each diffractive element of the plurality thereof into a beamlet (324);
controlling a first position of each diffractive element along a first direction (D1) in the first plane, wherein the phase of each beamlet of the plurality thereof is based on the first position; and
combining the plurality of beamlets to form an output signal (326).

16. The method of claim 15 further comprising providing the OPA such that it comprises a plurality of grating elements (302), each grating element including:
a diffractive element of the plurality thereof; and
an actuator (306) that is operatively coupled with the diffractive element;
wherein the actuator is configured to control the first position of its respective diffractive element.

17. The method of claim 16 wherein at least a portion of the actuator (502) is located underneath its respective diffractive element.

18. The method of claim 15 wherein the plurality of diffractive elements are arranged in an arrangement that is periodic in at least one dimension.

19. The method of claim 15 wherein the first position of each of the plurality of diffractive elements is controlled such that the output signal includes a plurality of output beams.

20. The method of claim 19 further comprising controlling the plurality of first positions to independently control each output beam of the plurality thereof.

21. The method of claim 15 wherein the plurality of diffractive elements are arranged in an arrangement that is two-dimensional.

22. The method of claim 21 wherein the arrangement is periodic in at least one dimension.

23. The method of claim 22 wherein the arrangement is aperiodic in at least one dimension.

24. The method of claim 22 wherein the arrangement is characterized by a first pitch along a second direction that is orthogonal with the first direction within the first plane, and wherein the ratio of the wavelength of the first optical beam to the first pitch is within the range of approximately 0.1 to approximately 2.

25. The method of claim 24 wherein the arrangement is characterized by a second pitch along the first direction, and wherein the ratio of the wavelength of the first optical beam to the second pitch is within the range of approximately 0.1 to approximately 2.

26. The method of claim 15 wherein the arrangement is one-dimensional and linear in a second direction that is orthogonal with the first direction within the first plane, and wherein the ratio of the wavelength of the first optical beam to the first pitch is within the range of approximately 0.1 to approximately 2.
